(19) United States
(12) Patent Application Publication
(10) Pub. No.: US 2025/0222834 A1
(43) Pub. Date: Jul. 10, 2025

(54) SEAT ADJUSTMENT APPARATUS AND SYSTEM FOR MOBILITY VEHICLE AND METHOD OF CONTROLLING THE SAME

(71) Applicants: HYUNDAI MOTOR COMPANY, Seoul (KR); KIA CORPORATION, Seoul (KR)

(72) Inventors: Sang Ah KO, Seoul (KR); Ji Hyun SONG, Suwon-si (KR); Sun Woo LEE, Seoul (KR); Seung Chan JO, Hwaseong-si (KR)

(73) Assignees: HYUNDAI MOTOR COMPANY, Seoul (KR); KIA CORPORATION, Seoul (KR)

(21) Appl. No.: 18/677,597

(22) Filed: May 29, 2024

(30) Foreign Application Priority Data
Jan. 5, 2024 (KR) 10-2024-0002182

(51) Int. Cl. B60N 2/02; B60N 2/16; B60N 2/30

(52) U.S. Cl. CPC B60N 2/0292; B60N 2/02253; B60N 2/0273; B60N 2/164; B60N 2/1695; B60N 2/3031; B60N 2/3065; B60N 2/309

(57) ABSTRACT

In a seat adjustment apparatus and system for a mobility vehicle and a method of controlling the same, a position and shape of a seat are automatically adjusted and optimized for an occupant based on the occupant's body type, whether the occupant is accompanied by a pet dog or item, whether an auxiliary device such as a wheelchair is used, and the like so that convenience for the occupant may be improved, and a position of a backrest portion and a position of a cushion portion may be adjusted, as necessary, which may minimize a useless space, and in which a state and situation of the occupant are optimized, and the position of the backrest portion and the position of the cushion portion are adjusted so that the satisfaction of the occupant in a compartment space may be ensured.

### CROSS-REFERENCE TO RELATED APPLICATION

The present application claims priority to Korean Patent Application No. 10-2024-0002182, filed on Jan. 5, 2024, the entire contents of which are incorporated herein for all purposes by this reference.

### BACKGROUND OF THE PRESENT DISCLOSURE

### Field of the Present Disclosure

The present disclosure relates to a seat adjustment apparatus and system for a mobility vehicle and a method of controlling the same, which are capable of automatically adjusting a position and shape of a seat depending on the type of occupant to improve convenience for the occupant.

### Description of Related Art

Mobility vehicles including vehicles, in which occupants are seated, are provided with seats to ensure convenience for the occupants. The seat allows the occupant to be seated in a comfortable posture so that the occupant does not get tired even on long trips.

The seat is fixed in position in a cabin, and the occupant needs to manually adjust positions of a cushion and a seatback.

Meanwhile, the occupants seated in the mobility vehicle have various body sizes, and the mobility vehicle is required to have spaces suitable for various situations in which the occupant carries items, the occupant is accompanied by a pet dog, or the occupant is seated in a wheelchair.

However, the occupants need to manually adjust the positions of the seats provided in a compartment space in the cabin so that the positions of the seats are suitable for the occupants, which causes discomfort.

Furthermore, because the cushion of the seat is fixed to a floor, a useless space and an installation area are increased, and convenience of use is degraded.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a seat adjustment apparatus and system for a mobility vehicle and a method of controlling the same, which are configured for automatically adjusting a position and shape of a seat depending on the type of an occupant to improve convenience for the occupant.

To achieve the above-mentioned object, the present disclosure provides a seat adjustment apparatus for a mobility vehicle, the seat adjustment apparatus including: a guide rail extending in an upward and downward direction; a movement unit including a movement portion and a first drive portion, in which the movement portion engaged to the guide rail is movable along the guide rail, and the first drive portion is provided on the movement portion and configured to move the movement portion in the upward and downward direction; a seat unit including a backrest portion and a cushion portion, in which the backrest portion is connected to the movement portion, the cushion portion pivotally coupled to the backrest portion is rotatable relative to the backrest portion and includes a second drive portion configured to adjust a rotation angle of the cushion portion with respect to the backrest portion; and a tilt unit including a third drive portion and a rotation link portion including a plurality of links, in which the rotation link portion is coupled to the backrest portion and the movement portion, and the third drive portion is connected to the rotation link portion so that the backrest portion moves in a forward and rearward direction as the links are rotated by operation of the third drive portion.

The third drive portion may be provided on the movement portion, the rotation link portion may include a first link and a second link, and the first link and the second link may be rotatably coupled to each other in a state in which the first link is connected to the third drive portion and the second link is rotatably connected to the backrest portion.

The tilt unit may further include a stationary link portion, and the stationary link portion may have one end portion connected to the movement portion, and the other end portion rotatably connected to an upper portion of the backrest portion.

The rotation link portion may be positioned below the stationary link portion and connected to the movement portion and the backrest portion.

An overall length of the stationary link portion may be shorter than an overall length of the rotation link portion.

The seat adjustment apparatus may further include: a support unit including a support portion and a fourth drive portion, in which the support portion is configured to be movable in a longitudinal direction of the cushion portion, and the fourth drive portion is provided on the cushion portion, connected to the support portion, and configured to adjust a position of the support portion.

A stationary rail may be provided on the cushion portion and extend in the longitudinal direction, and the support portion may be slidably provided on the stationary rail.

The fourth drive portion may include a pinion portion fixed to the cushion portion and configured to rotate in response that power is transmitted thereto, and a rack portion may be provided on the support portion and engage with the pinion portion.

The seat adjustment apparatus may further include: a controller configured to control the movement unit, the seat unit, the tilt unit, and the support unit and control a position of the backrest portion, a position of the cushion portion, and a position of the support portion by receiving information on an occupant.

Meanwhile, a method of controlling the seat adjustment apparatus for a mobility vehicle includes: an identification step of identifying information on an occupant; a derivation step of deriving a position of the backrest portion and a position of the cushion portion optimized for the occupant by analyzing the information on the occupant; and a control step of adjusting the position of the backrest portion and the position of the cushion portion by controlling the movement unit, the seat unit, and the tilt unit.

The identification step may include identifying the occupant's body condition, and the derivation step may include deriving upward and downward positions of the backrest portion and upward and downward positions of the cushion portion suitable for the occupant's body condition by analyzing a seating posture based on the occupant's body condition.

In response that the controller identifies in the identification step that an accompanying object, including baggage or a pet animal, is present together with the occupant, an angle of the cushion portion may be derived in the derivation step so that the occupant or the accompanying object is supported in a state in which the backrest portion and the cushion portion are moved upwards.

In response that the controller identifies in the identification step that the occupant is get and seated in a movable module, a position of the backrest portion and a position of the cushion portion may be derived in the derivation step so that the backrest portion and the cushion portion are unfolded in a state in which the backrest portion and the cushion portion are moved upwards.

Meanwhile, a seat adjustment system for a mobility vehicle according to an exemplary embodiment of the present disclosure includes: a seat including a movement unit provided to be movable along a guide rail provided in a cabin, a seat unit including a backrest portion provided on movement unit, and a cushion portion having a rotation angle adjustable with respect to the backrest portion, a tilt unit provided to be movable along the movement unit, connected to the backrest portion, and configured to adjust a tilting angle of the backrest portion; a sensing portion configured to detect an occupant in the cabin or identify information on the occupant while performing communication; and a controller configured to control the movement unit, the seat unit, and the tilt unit and control a position of the backrest portion and a position of the cushion portion based on the information on the occupant inputted through the sensing portion.

The sensing portion may recognize a seating position of the occupant identified together with the information on the occupant, and the controller may be configured for controlling the position of the backrest portion and the position of the cushion portion position of the seat corresponding to the seating position of the occupant.

According to the seat adjustment apparatus and system for a mobility vehicle and the method of controlling the same, which are structured as described above, the position and shape of the seat may be automatically adjusted and optimized for the occupant based on the occupant's body type, whether the occupant is accompanied by a pet dog or item, whether an auxiliary device such as a wheelchair is used, and the like, improving the convenience for the occupant.

Furthermore, because the position of the backrest portion and the position of the cushion portion are adjusted, as necessary, a useless space may be minimized, a state and situation of the occupant may be optimized, and the position of the backrest portion and the position of the cushion portion may be adjusted so that the occupant's satisfaction in the compartment space may be ensured.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a seat adjustment apparatus for a mobility vehicle according to an exemplary embodiment of the present disclosure.

FIG. 2 is a view exemplarily illustrating a deployed state of the seat adjustment apparatus for a mobility vehicle illustrated in FIG. 1.

FIG. 3 is a view exemplarily illustrating an exemplary embodiment in which a plurality of third drive portions are provided in the seat adjustment apparatus for a mobility vehicle illustrated in FIG. 1.

FIG. 4 is a view exemplarily illustrating an exemplary embodiment in which a single third drive portion is provided in the seat adjustment apparatus for a mobility vehicle illustrated in FIG. 1.

FIG. 5 is a cross-sectional side view of the seat adjustment apparatus for a mobility vehicle illustrated in FIG. 1.

FIG. 6 is a view exemplarily illustrating a seat unit and a support unit of the seat adjustment apparatus for a mobility vehicle illustrated in FIG. 1.

FIG. 7 is a view exemplarily illustrating the support unit of the seat adjustment apparatus for a mobility vehicle illustrated in FIG. 1.

FIG. 8 is a flowchart illustrating a method of controlling the seat adjustment apparatus for a mobility vehicle.

FIG. 9 is a view exemplarily illustrating an exemplary embodiment in which a seat for a mobility vehicle is adjusted in response that an occupant is an adult.

FIG. 10 is a view exemplarily illustrating an exemplary embodiment in which a seat for a mobility vehicle is adjusted in response that an occupant is a child.

FIG. 11 is a view exemplarily illustrating an exemplary embodiment in which a seat for a mobility vehicle is adjusted in response that an occupant is accompanied by a pet dog.

FIG. 12 is a view exemplarily illustrating an exemplary embodiment in which a seat for a mobility vehicle is adjusted in response that an occupant is seated in a wheelchair.

FIG. 13 is a configuration view exemplarily illustrating a seat adjustment system for a mobility vehicle.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments included in the present specification will be described in detail with reference to the accompanying drawings. The same or similar constituent elements are assigned with the same reference numerals regardless of reference numerals, and the repetitive description thereof will be omitted.

The suffixes “module”, “unit”, “part”, and “portion” used to describe constituent elements in the following description are used together or interchangeably to facilitate the description, but the suffixes themselves do not have distinguishable meanings or functions.

In the description of the exemplary embodiments included in the present specification, the specific descriptions of publicly known related technologies will be omitted in response that it is determined that the specific descriptions may obscure the subject matter of the exemplary embodiments included in the present specification. Furthermore, it should be interpreted that the accompanying drawings are provided only to allow those skilled in the art to easily understand the exemplary embodiments included in the present specification, and the technical spirit included in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

In response that one constituent element is described as being “coupled” or “connected” to another constituent element, it should be understood that one constituent element can be coupled or directly connected to another constituent element, and an intervening constituent element can also be present between the constituent elements. In response that one constituent element is described as being “directly coupled to” or “directly connected to” another constituent element, it should be understood that no intervening constituent element is present between the constituent elements.

Singular expressions include plural expressions unless clearly described as different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

A controller may include a communication device configured to communicate with another control unit or a sensor to control a corresponding function, a memory configured to store an operating system, a logic instruction, and input/output information, and one or more processors configured to perform determination, computation, decision, or the like required to control the corresponding function.

Hereinafter, a seat adjustment apparatus and system for a mobility vehicle and a method of controlling the same according to the exemplary embodiment of the present disclosure will be described with reference to the accompanying drawings.

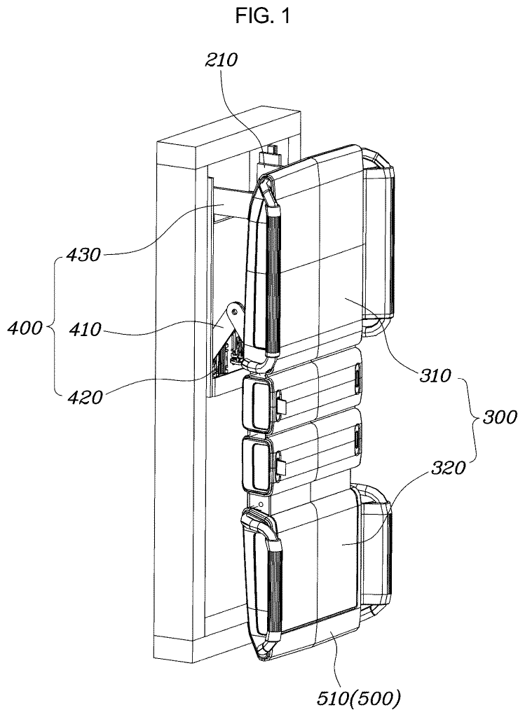

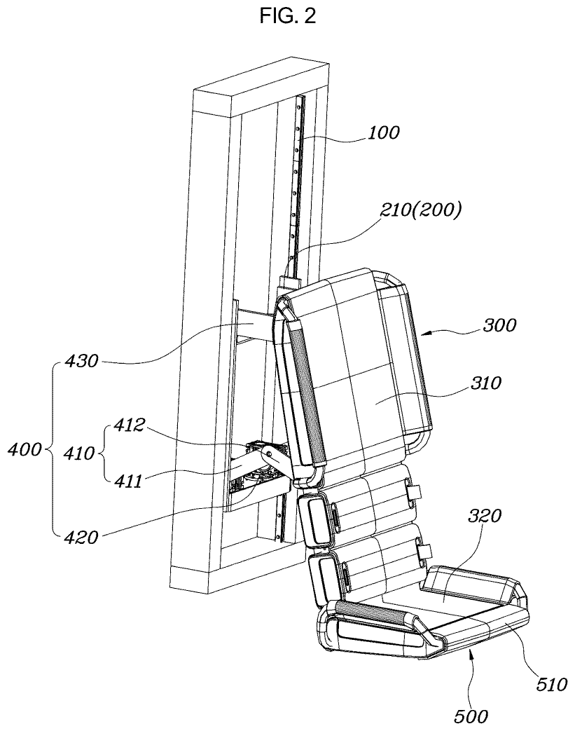

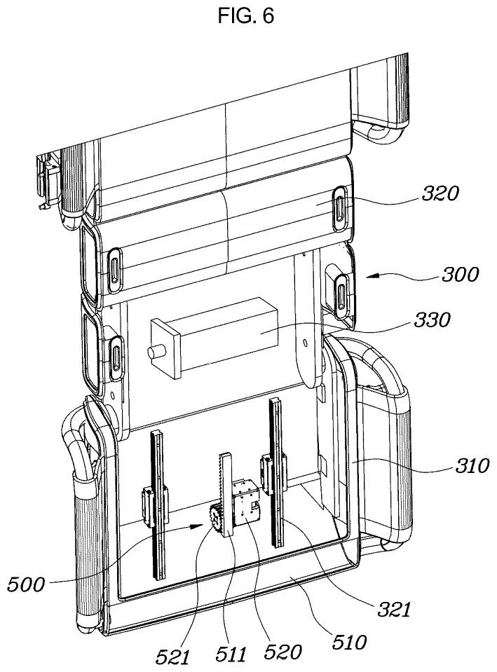

As illustrated in FIGS. 1 to 7, a seat adjustment apparatus for a mobility vehicle according to an exemplary embodiment of the present disclosure includes: guide rails 100 extending in an upward and downward direction thereof; a movement unit 200 including movement portions 210 and a first drive portion 220, in which movement portions 210 are provided to be movable along the guide rails 100, and the first drive portion 220 is provided on the movement portions 210 and configured to move the movement portions 210; a seat unit 300 including a backrest portion 310 and a cushion portion 320, in which the backrest portion 310 is connected to the movement portions 210, the cushion portion 320 is rotatably provided on the backrest portion 310 and includes a second drive portion 330 to adjust a rotation angle of the cushion portion 320 with respect to the backrest portion 310; and a tilt unit 400 including third drive portions 420 and rotation link portions 410 each including a plurality of links, in which the rotation link portions 410 are connected to the backrest portion 310 and the movement portions 210, and the third drive portions 420 are connected to the rotation link portions 410 so that the links are rotated by operations of the third drive portions 420, and the backrest portion 310 moves in a forward and rearward direction thereof.

The guide rails 100 are provided on an internal wall in a compartment space of the mobility vehicle while extending in the upward and downward direction and configured to allow the backrest portion 310 and the cushion portion 320, which form the seat unit 300, to move upward or downward.

The movement unit 200 includes the movement portions 210 and the first drive portion 220. The movement portions 210 are mounted on the guide rails 100 and provided to be movable along the guide rails 100. The first drive portion 220 is provided on the movement portion 210 and moves the movement portions 210. For example, the first drive portion 220 moves along the guide rails 100 extending in the upward and downward direction in the state in which the first drive portion 220 is connected to the movement portions 210. The guide rail 100 may be configured as a lead screw, and a motor includes a lead nut so that the movement portions 210 may move in the upward and downward direction thereof.

Furthermore, the guide rails 100 may be provided as a pair of guide rails 100. The movement portions 210 may be slidably mounted on the pair of guide rails 100 so that the upward and downward motions of the movement portions 210 may be stably performed.

Therefore, the backrest portion 310 and the cushion portion 320, which form the seat unit 300, may move upward or downward.

Meanwhile, the seat unit 300 includes the backrest portion 310 and the cushion portion 320. The backrest portion 310 and the cushion portion 320 are rotatably connected to each other so that an angle of the cushion portion 320 with respect to the backrest portion 310 may be adjusted.

The first drive portion 220 may be provided on the backrest portion 310 or the cushion portion 320 so that the angle of the cushion portion 320 may be automatically adjusted. That is, the second drive portion 330 may be provided at a portion where the backrest portion 310 and the cushion portion 320 are rotatably connected to each other. In the state in which the second drive portion 330 is connected to the cushion portion 320, the second drive portion 330 generates power to rotate the cushion portion 320.

The backrest portion 310 may be provided on the movement portion 210 and move together with the movement portions 210 in response that the movement portions 210 move along the guide rails 100 so that the upward and downward positions of the backrest portion 310 and the cushion portion 320 may be adjusted.

Therefore, the upward and downward positions of the backrest portion 310 and the cushion portion 320, which form the seat unit 300, may be adjusted, and the angle of the cushion portion 320 may be adjusted.

Meanwhile, the tilt unit 400 may include the rotation link portions 410 and the third drive portions 420, and the rotation link portion 410 may include the plurality of links.

The rotation link portion 410 includes the plurality of links, and any one link is connected to the third drive portion 420 so that the links are unfolded or folded by operation of the third drive portion 420, and the backrest portion 310 moves away from or toward the movement portions 210.

Therefore, the backrest portion 310 and the cushion portion 320, which form the seat unit 300, may be configured so that an angle of the backrest portion 310 may be adjusted.

As described above, the seat adjustment apparatus for a mobility vehicle of the present disclosure includes the movement unit 200, the seat unit 300, and the tilt unit 400. With the movement unit 200, the seat unit 300, which includes the backrest portion 310 and the cushion portion 320, may move in the upward/downward direction, and the angle of the cushion portion 320 with respect to the backrest portion 310 of the seat unit 300 may be adjusted. With the tilt unit 400, a tilting angle of the backrest portion 310 may be adjusted. Therefore, the present disclosure may adjust the positions of the backrest portion 310 and the cushion portion 320 while optimizing the positions of the backrest portion 310 and the cushion portion 320 for various states of the occupant, improving the convenience for the occupant.

Hereinafter, the present disclosure will be described.

The position of the seat unit 300 may be adjusted in the upward and downward direction by the movement unit 200.

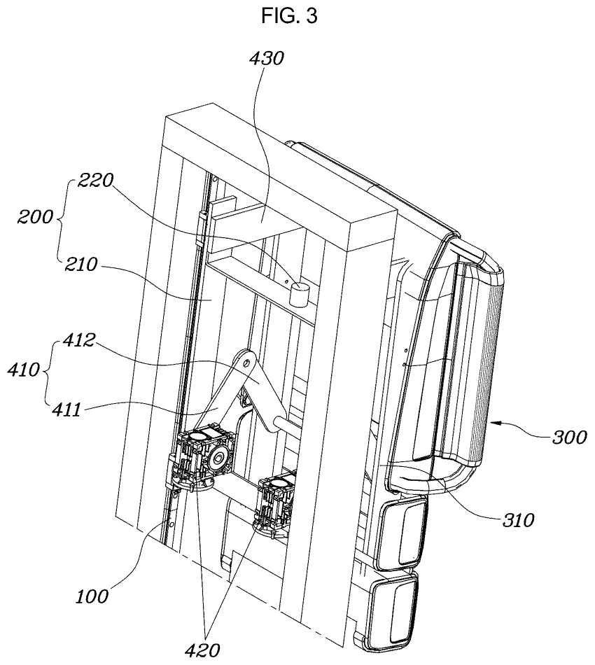

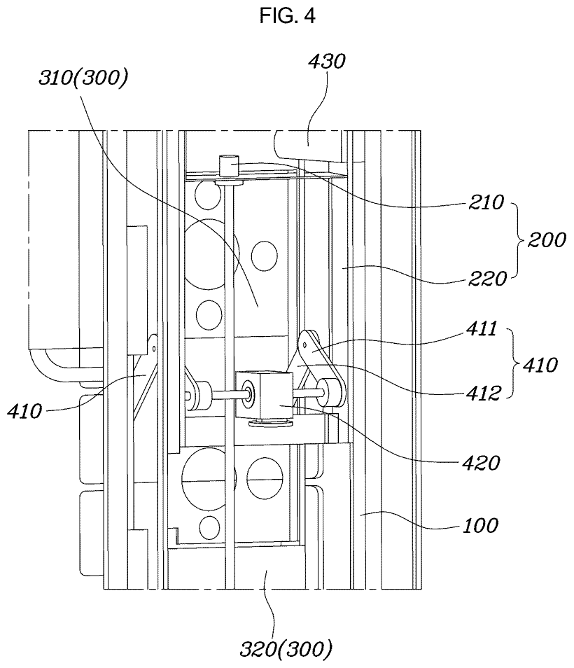

As illustrated in FIG. 3 and FIG. 4, the movement unit 200 includes the movement portions 210 and the first drive portion 220. The movement portion 210 may be mounted on the guide rail 100 and move along the guide rail 100. The first drive portion 220 includes a motor and a guide rod extending in the same direction as the guide rail 100. The first drive portion 220 is connected to the movement portions 210 to allow the movement portions 210 to move along the guide rails 100 while moving along the guide rod. In the instant case, the guide rod may be configured as a screw, and the motor may include a nut. As described above, the movement portions 210 rectilinearly move along the guide rails 100 by receiving a rotation force from the first drive portion 220 so that the upward and downward positions of the seat unit 300 may change.

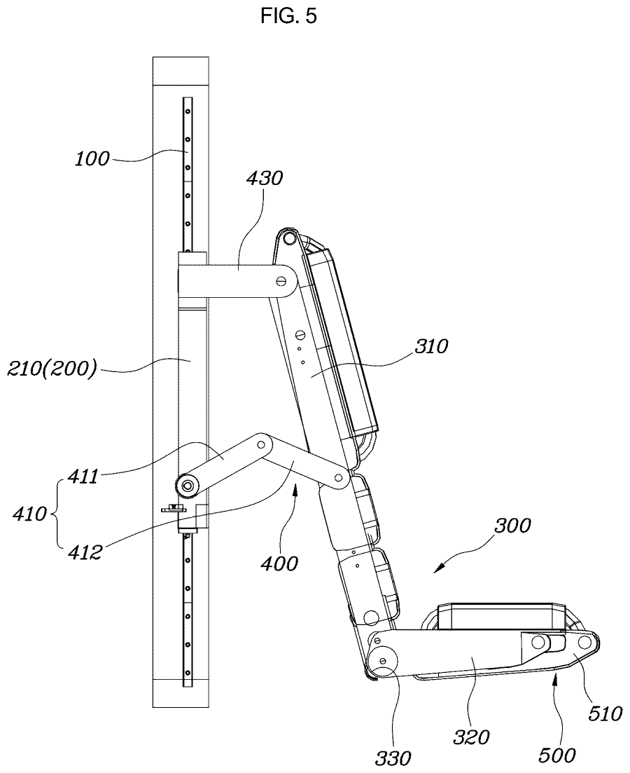

Meanwhile, as illustrated in FIG. 3, FIG. 4, and FIG. 5, the cushion portion 320 may be rotatably connected to the backrest portion 310 of the seat unit 300 so that the angle of the cushion portion 320 may be adjusted. The backrest portion 310 and the cushion portion 320 may be rotatably connected to each other by a recliner, and the second drive portion 330 may adjust a rotation angle of the cushion portion 320. The second drive portion 330 may include a motor. The second drive portion 330 may be connected to a hinge shaft of the cushion portion 320 or connected to a recliner so that the rotation angle of the cushion portion 320 may be adjusted by rotational power.

Furthermore, the second drive portion 330 may be provided as a plurality of second drive portions 330, as illustrated in FIG. 3, or the second drive portion 330 may be provided as a single second drive portion 330, as illustrated in FIG. 4.

Meanwhile, the tilting angle of the backrest portion 310 may be adjusted by the tilt unit 400.

The third drive portion 420 may be provided on the movement portion 210, and the rotation link portion 410 may include a first link 411 and a second link 412. The first link 411 and the second link 412 may be rotatably connected to each other in a state in which the first link 411 is connected to the third drive portion 420 and the second link 412 is rotatably connected to the backrest portion 310.

As illustrated in FIGS. 3 and 5, the rotation link portion 410 may include the first link 411 and the second link 412, and the links may be hingedly connected to each other and rotate relative to each other. In the instant case, the first link 411 may be connected to the third drive portion 420 and rotated by operation of the third drive portion 420. The second link 412 is rotatably connected to the backrest portion 310.

Therefore, in response that the third drive portion 420 operates, the first link 411 rotates to push and unfold the second link 412 or pull and fold the second link 412. Therefore, the backrest portion 310 may operate in conjunction with the rotations of the first and second links 411 and 412 so that the tilting angle may be adjusted.

Meanwhile, as may be seen in FIG. 3, FIG. 4, and FIG. 5, the tilt unit 400 may further include a stationary link portion 430. One end portion of the stationary link portion 430 may be connected to the movement portion 210, and the other end portion of the stationary link portion 430 may be rotatably connected to an upper portion of the backrest portion 310.

The stationary link portion 430 may be provided in a form of a bar. One end portion of the stationary link portion 430 is fixed to the movement portion 210 so that the backrest portion 310 may move together with the movement portion 210 in the upward and downward direction thereof. The other end portion of the stationary link portion 430 is rotatably connected to the upper portion of the backrest portion 310 so that the backrest portion 310 may tilt relative to the stationary link portion 430. That is, the upper portion of the backrest portion 310 is rotatably connected to the stationary link portion 430 so that the tilting operation may be performed as a lower portion of the backrest portion 310 and the cushion portion 320 move in the forward and rearward direction thereof.

In the instant case, the rotation link portion 410 may be positioned below the stationary link portion 430 and connected to the movement portion 210 and the backrest portion 310. Therefore, because the upper portion of the backrest portion 310 may be rotatably connected to the stationary link portion 430, a rotation center point may be defined on the upper portion of the backrest portion 310. The tilting operation may be performed as the lower portion of the backrest portion 310 moves in the forward and rearward direction in conjunction with the rotations of the links of the rotation link portion 410.

Furthermore, an overall length of the stationary link portion 430 may be shorter than an overall length of the rotation link portion 410. That is, because the overall length of the first and second links 411 and 412, which form the rotation link portion 410, is longer than the length of the stationary link portion 430, the links of the rotation link portion 410 rotate and extend to be longer than the stationary link portion 430 so that the links of the rotation link portion 410 are unfolded, pushing the backrest portion 310.

As described above, the stationary link portion 430 is connected to the upper portion of the backrest portion 310, and the links of the rotation link portion 410 operate in conjunction with the rotation of the third drive portion 420 so that the tilting operation may be performed.

Meanwhile, a support unit 500 may be further provided on the cushion portion 320 of the seat unit 300. The support unit 500 includes a support portion 510 and a fourth drive portion 520.

In the instant case, the support portion 510 may be provided on the cushion portion 320 and expand a width of the cushion portion 320 while moving in a longitudinal direction of the cushion portion 320. That is, the support portion 510 may be configured as a leg rest configured to be moved by the fourth drive portion 520 to adjust an overall area of the cushion portion 320.

Stationary rails 321 may be provided on the cushion portion 320 and extend in the longitudinal direction, and the support portion 510 may be slidably provided on the stationary rails 321.

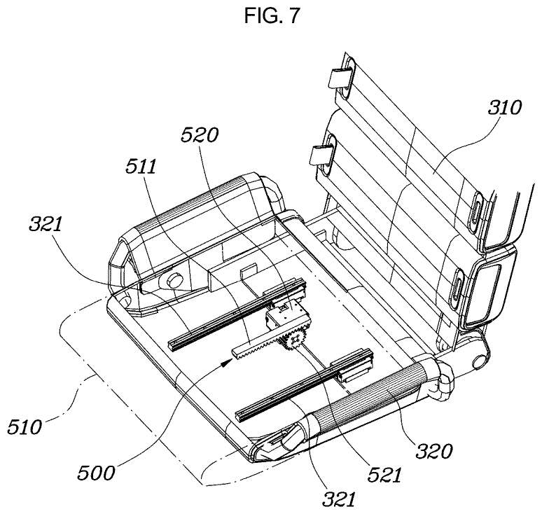

As illustrated in FIG. 7, the stationary rails 321 are fixed to the cushion portion 320 and extend in the longitudinal direction of the cushion portion 320. The support portion 510 is slidably connected to the stationary rails 321 so that the support portion 510 may move in an extension direction of the stationary rails 321.

The fourth drive portion 520 may include a pinion portion 521 fixed to the cushion portion 320 and configured to rotate in response that power is transmitted thereto, and a rack portion 511 provided on the support portion 510 and configured to engage with the pinion portion 521.

That is, the second drive portion 330 may include the motor. In response that the pinion portion 521 is rotated by operation of the motor, the rack portion 511, which engages with the pinion portion 521, may move together with the support portion 510 while moving rectilinearly. Therefore, the rack portion 511 may extend in the same direction as the stationary rail 321, and a movement amount of the support portion 510 may be determined depending on a length of the rack portion 511.

As described above, according to an exemplary embodiment of the present disclosure, the movement unit 200, the seat unit 300, the tilt unit 400, and the support unit 500 may variously adjust the upward and downward positions of the seat unit 300, the rotation angle of the cushion portion 320, the tilting angle of the backrest portion 310, and the width of the cushion portion 320.

The movement unit 200, the seat unit 300, the tilt unit 400, and the support unit 500 may be controlled by a controller 600. The controller 600 may receive information on the occupant and control the position of the backrest portion 310, the position of the cushion portion 320, and the position of the support portion 510.

In the instant case, the information on the occupant may be obtained by a sensor such as a camera, and the occupant's height, whether the occupant is accompanied by a pet dog, whether the occupant is seated in a wheelchair, and the like may be recognized based on the information on the occupant. The information on the occupant may be information that the occupant inputs while performing communication with the mobility vehicle.

Based on the information on the occupant, the controller 600 derives the position of the backrest portion 310, the position of the cushion portion 320, and the position of the support portion 510 that are optimized for the occupant, improving the convenience in response that the occupant seated in the compartment space of the cabin utilizes the seat unit 300.

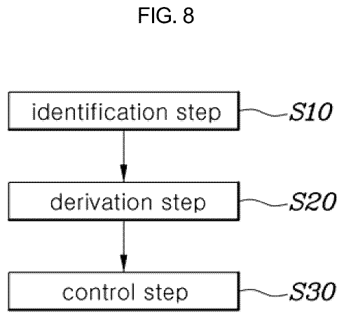

Meanwhile, as illustrated in FIG. 8, a method of controlling the seat adjustment apparatus for a mobility vehicle according to an exemplary embodiment of the present disclosure includes: an identification step S10 of identifying information on the occupant; a derivation step S20 of deriving the position of the backrest portion 310 and the position of the cushion portion 320 optimized for the occupant by analyzing the information on the occupant; and a control step S30 of adjusting the position of the backrest portion 310 and the position of the cushion portion 320 by controlling the movement unit 200, the seat unit 300, and the tilt unit 400.

The position of the backrest portion 310 and the position of the cushion portion 320 may be adjusted by the identification step $10, the derivation step S20, and the control step S30 under the control of the controller 600.

In the identification step S10, the information on the occupant may be identified by a camera provided in the cabin or at the door side through which the occupant is seated in the mobility vehicle, or the information on the occupant may be identified as the occupant performs in advance communication with the mobility vehicle.

In the identification step S10, various pieces of information on the occupant, such as the occupant's height, the occupant's state, baggage sizes, whether the occupant is accompanied by a pet dog, and whether the occupant is seated in a wheelchair, may be identified.

In response that the information on the occupant is identified as described above, the position of the backrest portion 310 and the position of the cushion portion 320 are adjusted in the derivation step S20. That is, in the derivation step S20, the optimal position of the backrest portion 310 and the optimal position of the cushion portion 320 are derived by the movement unit 200, the seat unit 300, and the tilt unit 400 under the control of the support unit 500 depending on the information on the occupant.

In response that the optimal position of the backrest portion 310 and the optimal position of the cushion portion 320 are derived as described above, the backrest portion 310 and the cushion portion 320 are moved to finally determined positions by controlling the movement unit 200, the seat unit 300, the tilt unit 400, and the support unit 500 in the control step S30.

The exemplary embodiment of the present disclosure related to the control will be described. In the identification step S10, the occupant's body condition may be identified. In the derivation step S20, a seating posture may be analyzed in accordance with the occupant's body condition, and the upward and downward positions of the backrest portion 310 and the upward and downward positions of the cushion portion 320, which are suitable for the occupant's body condition, may be derived.

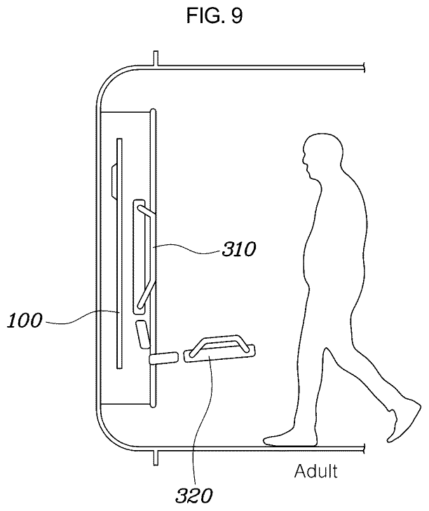

For example, as illustrated in FIG. 9, in response that the information on the occupant indicates that the occupant is identified as an adult with a large body in the identification step S10, the position of the cushion portion 320 is derived in the derivation step S20 so that a height of the seat unit 300 may be raised in accordance with the occupant's body condition, and the occupant may be seated. Therefore, in the control step S30, the position of the backrest portion 310 and the position of the cushion portion 320 are adjusted by controlling the movement unit 200, the seat unit 300, and the tilt unit 400 based on the derived control value.

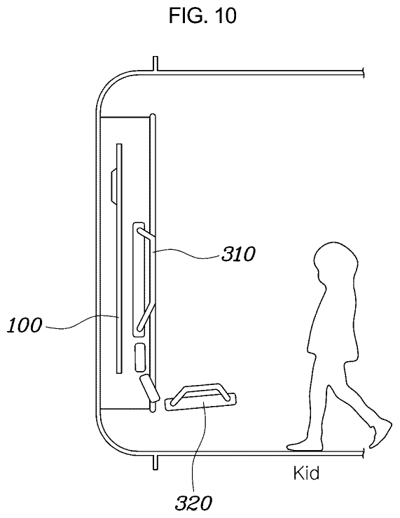

Furthermore, as illustrated in FIG. 10, the information on the occupant indicates that the occupant is identified as a child with a small body in the identification step S10, the position of the cushion portion 320 may be derived, and the seat unit 300 may be controlled so that the height of the seat unit may be lowered, and the occupant may be seated.

Meanwhile, in case that the information indicates that an accompanying object, such as baggage or a pet, is present together with the occupant in the identification step S10, the angle of the cushion portion 320 may be derived in the derivation step S20 so that the occupant or the accompanying object may be supported in the state in which the backrest portion 310 and the cushion portion 320 are moved upwards.

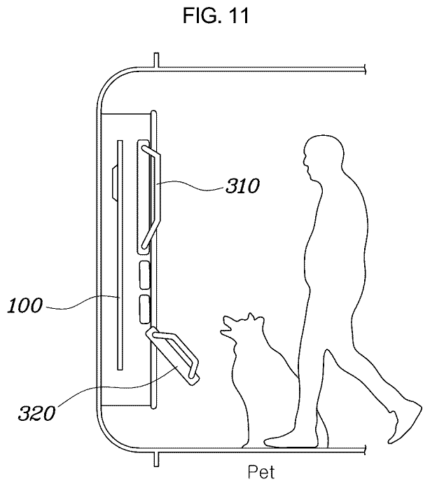

As illustrated in FIG. 11, in response that the information indicates that the occupant is accompanied by a pet dog in the identification step S10, the position of the backrest portion 310 and the position of the cushion portion 320 are derived in the derivation step S20 so that the height of the seat unit may be adjusted in accordance with the occupant's body condition, the occupant may recline on the backrest portion, and the occupant may be seated together with the pet dog. Therefore, in the control step S30, the position of the backrest portion 310 and the position of the cushion portion 320 are adjusted by controlling the movement unit 200, the seat unit 300, and the tilt unit 400 based on the derived control value.

Meanwhile, in response that the information indicates that the occupant is get and seated in the mobility vehicle in the identification step S10, the position of the backrest portion 310 and the position of the cushion portion 320 may be derived in the derivation step S20 so that the backrest portion 310 and the cushion portion 320 are unfolded in the state in which the backrest portion 310 and the cushion portion 320 are moved upwards.

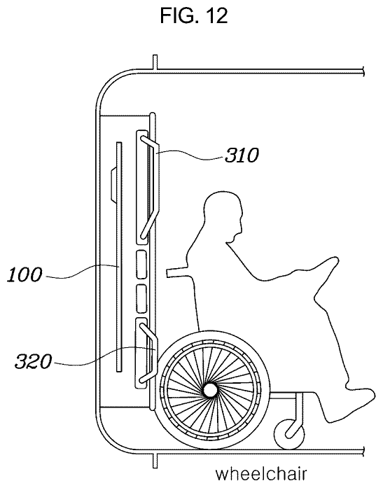

As illustrated in FIG. 12, in response that the information indicates that the occupant seated in a wheelchair enters the compartment space of the cabin in the identification step S10, the position of the backrest portion 310 and the position of the cushion portion 320 are derived in the derivation step S20 so that the wheelchair may be fixed to a safety device provided in the cabin without interfering with the seat unit 300. In the instant case, the backrest portion 310 and the cushion portion 320 may be unfolded in a straight state. In the control step S30, the position of the backrest portion 310 and the position of the cushion portion 320 are adjusted by controlling the movement unit 200, the seat unit 300, and the tilt unit 400 based on the derived control value.

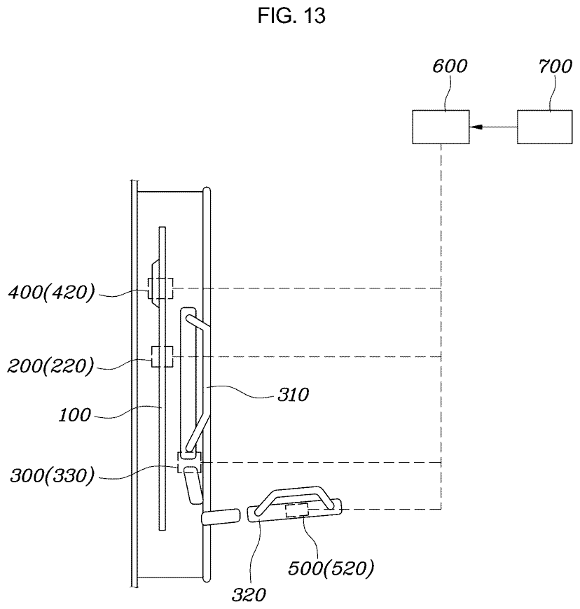

Meanwhile, as illustrated in FIG. 13, a seat adjustment system for a mobility vehicle according to an exemplary embodiment of the present disclosure includes: the seat including the movement unit 200 provided to be movable along the guide rail 100 provided in the cabin, the seat unit 300 including the backrest portion 310 provided on the movement unit 200 and the cushion portion 320 including the rotation angle adjustable with respect to the backrest portion 310, and the tilt unit 400 provided to be movable along the movement unit 200, connected to the backrest portion 310, and configured to adjust the tilting angle of the backrest portion 310; a sensing portion 700 configured to detect the occupant in the cabin or identify the information on the occupant while performing communication; and the controller 600 configured to control the movement unit 200, the seat unit 300, and the tilt unit 400 and control the position of the backrest portion 310 and the position of the cushion portion 320 based on the information on the occupant inputted through the sensing portion 700.

As described above, the present disclosure provides the movement unit 200, the seat unit 300, and the tilt unit 400. With the movement unit 200, the seat unit 300, which includes the backrest portion 310 and the cushion portion 320, may move in the upward/downward direction, and the angle of the cushion portion 320 with respect to the backrest portion 310 of the seat unit 300 may be adjusted. With the tilt unit 400, the tilting angle of the backrest portion 310 may be adjusted. Therefore, the present disclosure may adjust the positions of the backrest portion 310 and the cushion portion 320 while optimizing the positions of the backrest portion 310 and the cushion portion 320 for various states of the occupant, improving the convenience for the occupant.

The sensing portion 700 may be a camera provided in the door or cabin. Alternatively, the sensing portion 700 may be a communication device configured for performing communication with the occupant. The sensing portion 700 may collect the information on the occupant seated in the compartment space of the cabin.

The controller 600 adjusts the position of the backrest portion 310 and the position of the cushion portion 320 to the positions optimized for the occupant by controlling the movement unit 200, the seat unit 300, and the tilt unit 400 based on the information on the occupant inputted through the sensing portion 700.

The sensing portion 700 may recognize the seating position of the occupant identified together with the information on the occupant. The controller 600 may be configured for controlling the position of the backrest portion 310 and the position of the cushion portion 320 of the seat corresponding to the seating position of the occupant.

As described above, in case that a plurality of occupants is seated in the compartment space of the cabin of the mobility vehicle, the sensing portion 700 may identify the information on the occupant for each of the occupants and recognize the seating position of the occupant so that the backrest portion 310 and the cushion portion 320 of the seat unit 300, in which the occupant intends to be seated, may be adjusted and optimized for the occupant based on the information on the occupant identified for each of the occupants.

According to the seat adjustment apparatus and system for a mobility vehicle and the method of controlling the same, which are structured as described above, the position and shape of the seat may be automatically adjusted and optimized for the occupant based on the occupant's body type, whether the occupant is accompanied by a pet dog or item, whether an auxiliary device such as a wheelchair is used, and the like, improving the convenience for the occupant.

Furthermore, because the position of the backrest portion 310 and the position of the cushion portion 320 are adjusted, as necessary, a useless space may be minimized, a state and situation of the occupant may be optimized, and the position of the backrest portion 310 and the position of the cushion portion 320 may be adjusted so that the occupant's satisfaction in the compartment space may be ensured.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A seat adjustment apparatus for a mobility vehicle, the seat adjustment apparatus including:
a guide rail extending in an upward and downward direction;
a movement unit including a movement portion and a first drive portion, wherein the movement portion engaged to the guide rail is movable along the guide rail, and the first drive portion is provided on the movement portion and configured to move the movement portion in the upward and downward direction;
a seat unit including a backrest portion and a cushion portion, wherein the backrest portion is connected to the movement portion, the cushion portion pivotally coupled to the backrest portion is rotatable relative to the backrest portion and includes a second drive portion configured to adjust a rotation angle of the cushion portion with respect to the backrest portion; and
a tilt unit including a third drive portion and a rotation link portion including a plurality of links, wherein the rotation link portion is coupled to the backrest portion and the movement portion, and the third drive portion is connected to the rotation link portion so that the backrest portion moves in a forward and rearward direction as the links are rotated by operation of the third drive portion.

2. The seat adjustment apparatus of claim 1, wherein the third drive portion is provided on the movement portion, the rotation link portion includes a first link and a second link, and the first link and the second link are rotatably coupled to each other in a state in which the first link is connected to the third drive portion and the second link is rotatably connected to the backrest portion.

3. The seat adjustment apparatus of claim 1, wherein the tilt unit further includes a stationary link portion, and the stationary link portion includes a first end portion connected to the movement portion, and a second end portion rotatably coupled to an upper portion of the backrest portion.

4. The seat adjustment apparatus of claim 3, wherein the rotation link portion is positioned below the stationary link portion and connected to the movement portion and the backrest portion.

5. The seat adjustment apparatus of claim 4, wherein an overall length of the stationary link portion is shorter than an overall length of the rotation link portion.

6. The seat adjustment apparatus of claim 1, further including:
a support unit including a support portion and a fourth drive portion,
wherein the support portion is configured to be movable in a longitudinal direction of the cushion portion, and the fourth drive portion is provided on the cushion portion, connected to the support portion, and configured to adjust a position of the support portion.

7. The seat adjustment apparatus of claim 6, wherein a stationary rail is mounted on the cushion portion and extends in the longitudinal direction, and the support portion is slidably provided on the stationary rail.

8. The seat adjustment apparatus of claim 6, wherein the fourth drive portion includes a pinion portion fixed to the cushion portion of the cushion portion and configured to rotate in response that power is transmitted thereto, and a rack portion is provided on the support portion and engaged with the pinion portion.

9. The seat adjustment apparatus of claim 6, further including:
a controller configured to control the movement unit, the seat unit, the tilt unit, and the support unit and control a position of the backrest portion, a position of the cushion portion, and a position of the support portion by receiving information on an occupant.

10. A method of controlling the seat adjustment apparatus for the mobility vehicle of claim 1, the method comprising:
an identification step of identifying information on an occupant;
a derivation step of deriving a position of the backrest portion and a position of the cushion portion optimized for the occupant by analyzing the information on the occupant; and
a control step of adjusting the position of the backrest portion and the position of the cushion portion by controlling the movement unit, the seat unit, and the tilt unit.

11. The method of claim 10, wherein the identification step includes identifying the occupant's body condition, and the derivation step includes deriving upward and downward positions of the backrest portion and upward and downward positions of the cushion portion suitable for the occupant's body condition by analyzing a seating posture based on the occupant's body condition.

12. The method of claim 10, wherein in response that the controller identifies in the identification step that an accompanying object, including baggage or a pet animal, is present together with the occupant, an angle of the cushion portion is derived in the derivation step so that the occupant or the accompanying object is supported in a state in which the backrest portion and the cushion portion are moved upwards.

13. The method of claim 10, wherein in response that the controller identifies in the identification step that the occupant is get and seated in the mobility vehicle, a position of the backrest portion and a position of the cushion portion are derived in the derivation step so that the backrest portion and the cushion portion are unfolded in a state in which the backrest portion and the cushion portion are moved upwards.

14. A seat adjustment system for a mobility vehicle, the seat adjustment system comprising:
a seat including a movement unit provided to be movable along a guide rail provided in a cabin, a seat unit including a backrest portion provided on the movement unit, and a cushion portion having a rotation angle adjustable with respect to the backrest portion, a tilt unit provided to be movable along the movement unit, connected to the backrest portion, and configured to adjust a tilting angle of the backrest portion;
a sensing portion configured to detect an occupant in the cabin or identify information on the occupant while performing communication; and
a controller configured to control the movement unit, the seat unit, and the tilt unit and control a position of the backrest portion and a position of the cushion portion based on the information on the occupant inputted through the sensing portion.

15. The seat adjustment system of claim 14, wherein the controller is further configured to recognize a seating position of the occupant identified together with the information on the occupant via the sensing portion, and to control the position of the backrest portion and the position of the cushion portion position of the seat corresponding to the seating position of the occupant.

16. The seat adjustment system of claim 14,
wherein the movement unit includes a movement portion and a first drive portion, wherein the movement portion engaged to the guide rail is movable along the guide rail, and the first drive portion is provided on the movement portion and configured to move the movement portion in an upward and downward direction;
wherein the backrest portion is connected to the movement portion, the cushion portion pivotally coupled to the backrest portion is rotatable relative to the backrest portion and includes a second drive portion configured to adjust the rotation angle of the cushion portion with respect to the backrest portion; and
wherein the tilt unit includes a third drive portion and a rotation link portion including a plurality of links, the rotation link portion is coupled to the backrest portion and the movement portion, and the third drive portion is connected to the rotation link portion so that the backrest portion moves in a forward and rearward direction as the links are rotated by operation of the third drive portion.

17. The seat adjustment system of claim 16, wherein the third drive portion is provided on the movement portion, the rotation link portion includes a first link and a second link, and the first link and the second link are rotatably coupled to each other in a state in which the first link is connected to the third drive portion and the second link is rotatably connected to the backrest portion.

18. The seat adjustment system of claim 16, wherein the tilt unit further includes a stationary link portion, and the stationary link portion includes a first end portion connected to the movement portion, and a second end portion rotatably coupled to an upper portion of the backrest portion.

19. The seat adjustment system of claim 16, further including a support unit including a support portion and a fourth drive portion,
wherein the support portion is configured to be movable in a longitudinal direction of the cushion portion, and the fourth drive portion is provided on the cushion portion, connected to the support portion, and configured to adjust a position of the support portion, and
wherein a stationary rail is mounted on the cushion portion and extends in the longitudinal direction, and the support portion is slidably provided on the stationary rail.

20. The seat adjustment system of claim 19, wherein the fourth drive portion includes a pinion portion fixed to the cushion portion of the cushion portion and configured to rotate in response that power is transmitted thereto, and a rack portion is provided on the support portion and engaged with the pinion portion.
